(19) United States
(12) Patent Application Publication
(10) Pub. No.: US 2012/0030103 A1
(43) Pub. Date: Feb. 2, 2012

(54) Image-Based Submission and Verification of Redemption Codes

(76) Inventors: Gregory Hughes, Cupertino, CA (US); Ted Biskupski, Cupertino, CA (US); Glenn Epis, Sunnyvale, CA (US); Philip J. Luongo, JR., San Francisco, CA (US)

(21) Appl. No.: 12/844,703

(22) Filed: Jul. 27, 2010

(51) Int. Cl. G06Q 40/00; G06K 9/18

(52) U.S. Cl. 705/41; 382/182

(57) ABSTRACT

Improved systems and techniques for submission and verification of redemption codes are disclosed. It will be appreciated that the submission and verification techniques can, among other things, automate the submission and verification of redemption codes for various redeemable instruments, including transaction cards (e.g., gift or prepaid cards) widely used for online transactions (e.g., purchase of media items from an online media store). A redemption code can be determined based on an image of a redeemable instrument. More particularly, an image of a redeemable instrument can be processed using image analysis or one or more image processing techniques to extract a redemption code for the redeemable instrument. By way of example, an image (e.g., a digital picture) of a gift card can be processed by a device to extract an alphanumeric value printed on the gift card. This means that the alphanumeric value need not be entered manually by a person seeking to redeem the redeemable instrument (e.g., gift card). As a result, users can simply take a picture of a redeemable instrument (e.g., gift card) rather than having to manually enter long alphanumeric values commonly used today.

### BACKGROUND

Today, various forms of redeemable instruments are available. In particular, redeemable instruments in the form of transaction cards (e.g., gift cards, prepaid cards) are widely used. Generally, a gift or prepaid card does not have a value (e.g., monetary a value) until sold and activated. After activation, a redeemable value or amount can be assigned to the card. Typically, information stored on a gift or prepaid card can be used to identify the redeemable value when the gift or prepaid card is redeemed. By way of example, a number stored on a gift card can be used by a merchant or an online store to lookup the value assigned to the gift card at time when it was activated. Information can, for example, be stored on a barcode or magnetic stripe of a gift card. Typically, for security reasons, the redeemable value is not stored on the redeemable instrument itself.

More recently, transaction cards have become available for purchasing items online from online stores. The ability to purchase digital media items (e.g., music) for use with digital audio and video players allows owners of the digital audio and video players to download music onto their players. Gift cards or prepaid cards issued for websites that allow digital audio and/or video files to be purchased or otherwise obtained allow an owner of a gift card to use the monetary value of the gift card to purchase media items and download corresponding digital audio and/or video files. Online stores that allow monetary values associated with gift cards to be redeemed for media items include, for example, the iTunes® online store owned and operated by Apple Inc. of Cupertino, Calif.

As a result, the account number associated with the gift card may effectively be debited to effectuate the purchase of the media item. An account with an online store can be established or otherwise replenished using the value associated with the gift card.

To redeem a gift card at an online store, entry of a redemption code is required. Typically, a person attempting to redeem a gift or prepaid card is required to manually enter a the redemption code which is a long alphanumeric value (e.g., “1A76WJ789f8981A9”). The redemption code can be secured or sealed by a layer of material that can be scratched or peeled off to reveal the redemption code typically provided as an alphanumeric value or another readable form. For security, redemption codes are generally long. As such, manually entering a redemption code can be quite cumbersome, especially on a mobile device where having to enter a long redemption code can be very tedious and possibly frustrating.

### SUMMARY

Improved systems and techniques for submission and verification of redemption codes are disclosed. It will be appreciated that the submission and verification techniques can, among other things, automate the submission and verification of redemption codes for various redeemable instruments, including transaction cards (e.g., gift or prepaid cards) widely used for online transactions (e.g., purchase of media items from an online media store).

In accordance with one aspect of the system and techniques, a redemption code can be determined based on an image of a redeemable instrument. More particularly, an image of a redeemable instrument can be processed using image analysis or one or more image processing techniques to extract a redemption code for the redeemable instrument. By way of example, an image (e.g., a digital picture) of a redeemable instrument (e.g., gift card) can be processed by a device to extract an alphanumeric value printed on the redeemable instrument. This means that the alphanumeric value need not be entered manually by a person who seeks to redeem the redeemable instrument. As a result, a user can simply take a picture of a redeemable instrument rather than having to manually enter a long alphanumeric value.

In accordance with one exemplary embodiment, a method for allowing redemption of a redeemable instrument having a redeemable value can be provided. In accordance with the exemplary method, a least one image of a portion of the redeemable instrument can be obtained. Then, the at least one image can be processed to extract a redemption code that can be verified for redemption of the redemption value associated with the redeemable instrument.

In accordance with another exemplary embodiment, a device (e.g., a mobile phone, a personal computer, a server) can be operable to process at least one image of a redeemable instrument to extract a redemption code. It should be noted that the redemption code can be verified for redemption of a redemption value associated with the redeemable instrument. In accordance with another exemplary embodiment, the device may also be operable to obtain (e.g., receive, capture) one or more images of the redeemable instrument. In addition, in accordance with yet another exemplary embodiment, the device may be operable to extract the redemption code from one or more images of the redeemable instrument and transmit the redemption code for verification by another device.

In accordance with still another exemplary embodiment, a method for allowing redemption of a redeemable value associated with a redeemable instrument can be provided. In accordance with the exemplary method, a redemption code can be determined at least partly based on one or more images of a redeemable instrument. The exemplary method may also optionally determine whether the redemption code is valid and allow the redeemable value to be redeemed when it is determined that the redemption code is valid.

Another exemplary method processes a transaction card that includes a redemption code associated with a redeemable value. In accordance with the exemplary method, initially, an image of a redemption code can be located in an image of a transaction card. Then, the image can be processed to extract one or more characters representative of the redemption code. The exemplary method may optionally transmit the redemption code for verification.

As yet another exemplary embodiment, a computer readable storage medium can store executable computer code for processing a redeemable instrument indicative of at least one redemption value. The computer readable storage medium can include executable computer code for processing at least one image of the redeemable instrument to extract a redemption code that can be verified for redemption of at least one redemption value associated with the redeemable instrument.

### BRIEF DESCRIPTION OF THE DRAWINGS

The improved systems and techniques may best be understood by reference to the following description taken in conjunction with the accompanying drawings in which:

FIG. 1 depicts an image-based value redemption system in accordance with one exemplary embodiment.

FIG. 2 depicts a method for allowing redemption of a redeemable value associated with a redeemable instrument in accordance with one exemplary embodiment.

FIG. 3 depicts a communication environment in accordance with one exemplary embodiment.

FIG. 4 depicts a method for processing a redeemable (or redemption) instrument in accordance with one exemplary embodiment.

FIG. 5 depicts a method for processing a redeemable instrument in accordance with another exemplary embodiment.

FIG. 6 depicts a mobile device in a communication environment 300 in accordance with another exemplary embodiment.

FIGS. 7A, 7B and 7C depict a method for processing a redeemable instrument in accordance with still another exemplary embodiment.

FIG. 8 depicts a method for extracting a redemption code from an image of a redeemable instrument in accordance with an exemplary embodiment.

FIGS. 9A and 9B depict an exemplary prepaid or gift card suitable for verification and redemption by image-based verification and redemption.

### DETAILED DESCRIPTION OF EXEMPLARY EMBODIMENTS

Improved systems and techniques for submission and verification of redemption codes are disclosed. It will be appreciated that the submission and verification techniques can, among other things, automate the submission and verification of redemption codes for various redeemable instruments, including transaction cards (e.g., gift or prepaid cards) widely used for online transactions (e.g., purchase of media items from an online media store).

In accordance with one aspect of the system and techniques, a redemption code can be determined based on an image of a redeemable instrument. More particularly, an image of a redeemable instrument can be processed using image analysis or one or more image processing techniques to extract a redemption code for the redeemable instrument. By way of example, an image (e.g., a digital picture) of a redeemable instrument (e.g., gift card) can be processed by a device to extract an alphanumeric value printed on the redeemable instrument. This means that the alphanumeric value need not be entered manually by a person who seeks to redeem the redeemable instrument. As a result, a user can simply take a picture of a redeemable instrument rather than having to manually enter a long alphanumeric value. The improved techniques for submission and verification of redemption codes are particularly useful for mobile devices.

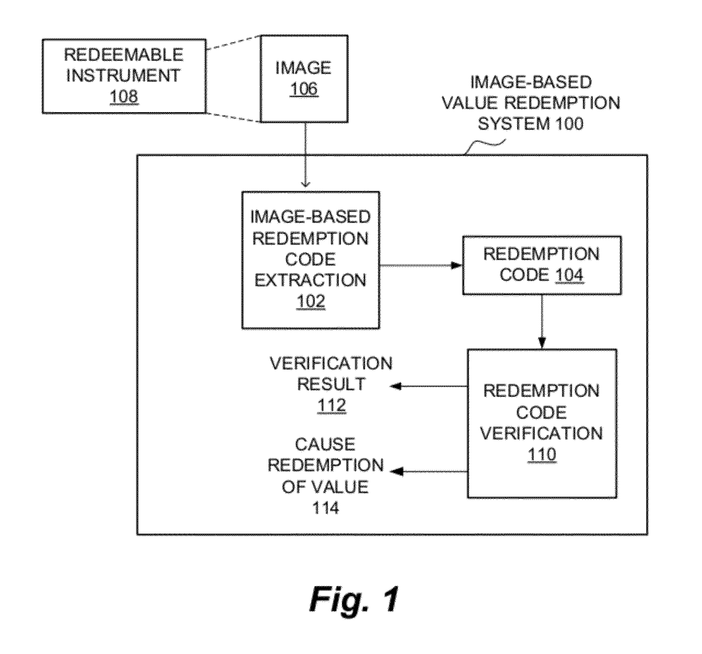

FIG. 1 depicts an image-based value redemption system 100 in accordance with one exemplary embodiment. Those skilled in the art will appreciate that the image-based value redemption system 100 can, for example, be provided as a computing system which may include one or more hardware components (e.g., one or more processors or processing cores, memory) and/or software (not shown). It will also be appreciated that that the computing systems can also include digital imaging hardware components (e.g., a camera) as well digital imaging and/or processing software.

Referring to FIG. 1, an image-based redemption code extraction component 102 is operable to determine a redemption code 104 as output based on an image 106 of a redeemable instrument 108 provided as input to the image-based value redemption system 100. The image 106 can, for example, be captured by a camera (not shown) which may or may not be part of the image-based value redemption system 100.

The redeemable instrument 108 can, for example, be a transaction card (e.g., a gift card). Generally, the redeemable instrument 108 is indicative of a redemption code (e.g., an alphanumeric value) provided for redemption of a value (e.g., a monetary value) associated with the redeemable instrument 108. The redemption code may be secured, for example, by a layer of material that can be peeled or scratched off in order to reveal the code to the purchaser of the redeemable instrument 108. In addition to the redemption code, the redeemable instrument 108 may include additional information (e.g., a serial number, a bar code) which can, for example, be used for activation or authentication of the redeemable instrument 108. By way of example, the redeemable instrument 108 can be a $50 gift card redeemable at an online store for a $50 credit that can be used to purchase items (e.g., downloadable songs and applications) available from the online store. As another example, the redeemable instrument 108 can be redeemable for one or more songs, albums and/or movies, a coupon, or entry into a contest or lottery.

Generally, the image 106 can be processed (image processing) to effectively extract the redemption code 104. As a result, the redemption code 104 can be determined automatically without requiring a user to manually enter the redemption code. Processing of the image 106 can depend on the type of the redemption code. As such, a general Optical Character Recognition (OCR) algorithm can be used to determine alphanumerical values. A “Quick Response” (QR) algorithm can be used for QR (or 2D) coded values. It should be noted that a customized (or specialized) algorithm can, for example, be used for determining redemption codes that have been provided in a scratch off or peel off portion of a transaction card. Peeling off or scratching off may remove a portion of the transaction code and/or cause residue to effectively obstruct a portion of the transaction code. For e.g., a customized OCR algorithm may be better suited when the redemption code 104 is provided as a scratch off or peel off.

In addition, it will be appreciated that additional measures can be taken into account for specific situations in which the image 106 is taken and information can be provided as feedback to facilitate capture of an image better suited for processing an extraction of a redemption code. By way of example, a user of a mobile device can be prompted that a brighter picture is needed, the camera needs to be closer to the redeemable instrument 108, or the camera should be held steady, etc. Additional examples of useful user prompts are discussed below.

Referring back to FIG. 1, the redemption code verification component 110 of the image-based value redemption system 100 can determine whether the redemption code 104 is valid. The redemption code 104 can be verified using a conventional verification technique for verification of redemption codes. As a result of a successful verification of the redemption code 104, the redemption code verification component 110 may cause (or facilitate) 114 redemption of a redemption value associated with the redeemable instrument 108. The redemption code verification component 110 can also output a verification result 112 indicative of successful or unsuccessful verification of the redemption code 104.

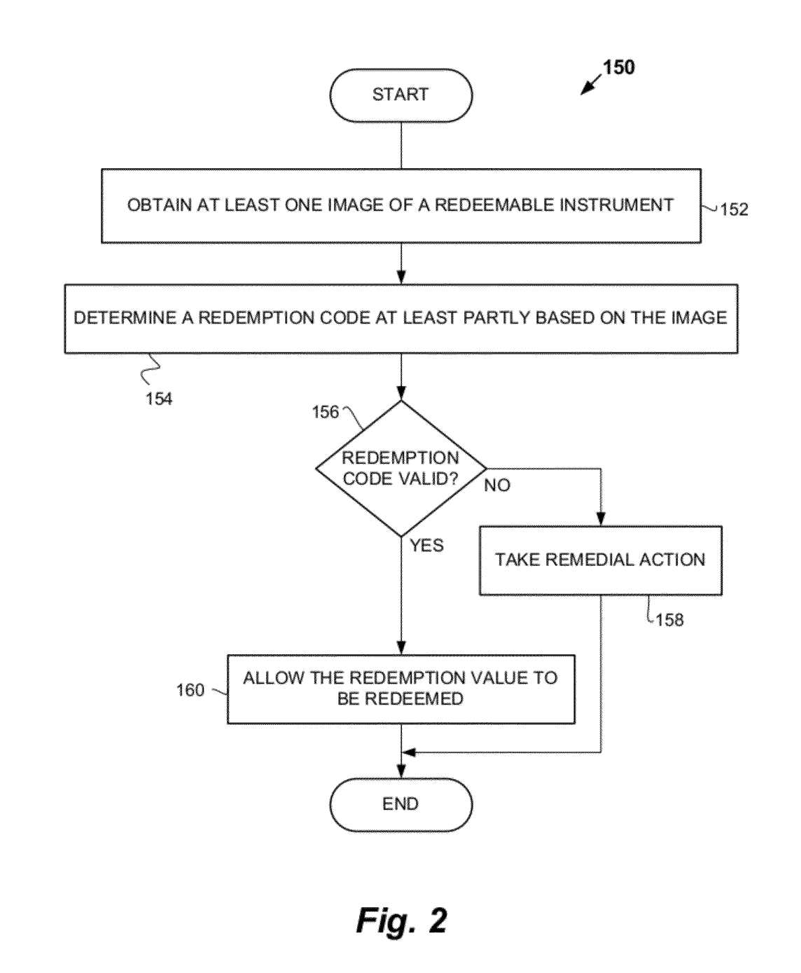

FIG. 2 depicts a method 150 for allowing redemption of a redeemable value associated with a redeemable instrument in accordance with one exemplary embodiment. Method 150 can, for example, be used by the image-based value redemption system 100 depicted in FIG. 1. Referring to FIG. 2, initially, at least one image of a redeemable instrument is obtained (152). Next, a redemption code is determined (154) at least partly based on the at least one image of the redeemable instrument. Subsequently, it is determined (156) whether the redemption code is valid. If it is determined (156) that the redemption code is not valid, remedial action can be taken (158) before the method 150 ends. By way of example, more elaborate image processing can be performed, an error can be output and/or another attempt can be made to determine a valid redemption code. On the other hand, if it is determined (156) that the redemption code is valid, the redemption value is permitted (or allowed) to be redeemed before the method 150 ends.

As noted above, the image-based value redemption system 100 (shown in FIG. 1) can include a combination of hardware and software components. It should also be noted that the components of the image-based value redemption system 100 may be distributed between multiple devices (e.g., computing or communication devices). By way of example, the image-based redemption code extraction component 102 may be operable on a first device (e.g., a client device, such as a mobile phone) and the redemption code verification component 110 may be operable on a second device (e.g., a server). Today, redemption codes are typically verified by or on behalf of an entity (e.g., an on-line store) independent of the entity (e.g., an individual) attempting redemption of the redeemable instrument 108. Generally, a request for redemption is submitted over a network or communication network (e.g., Internet). Given the current prevalence of communication over a network, this configuration will be discussed below.

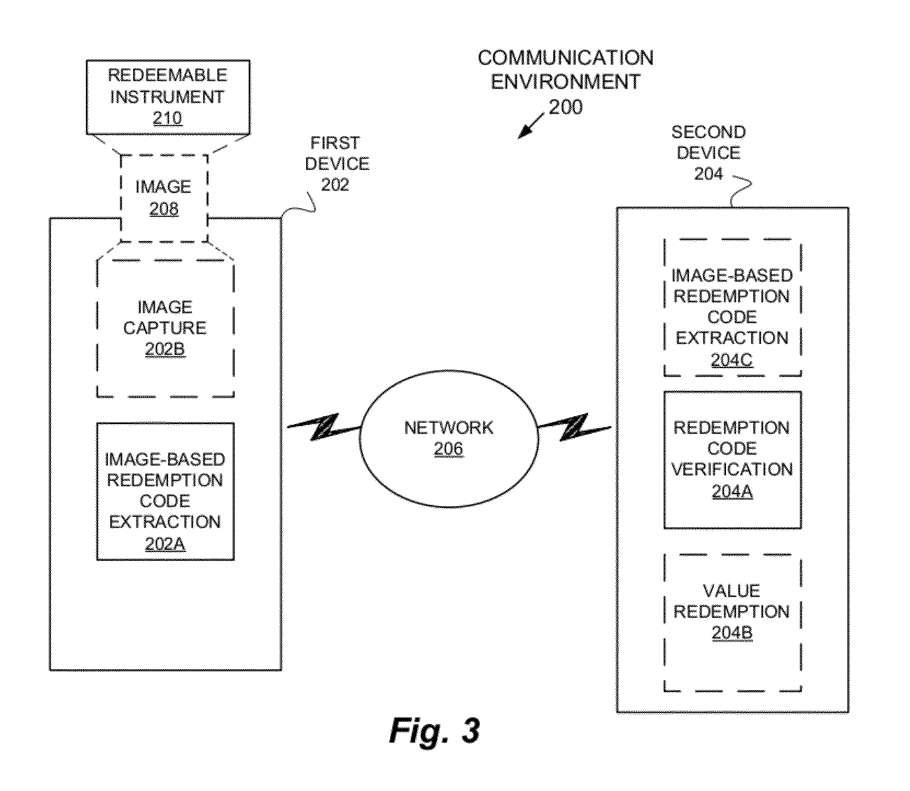

To further elaborate, FIG. 3 depicts a communication environment 200 in accordance with one exemplary embodiment. Referring to FIG. 3, first and second devices (e.g., computing devices or systems) 202 and 204 can communicate with each other over a network 206. The first device 202 can, for example, be a personal computer (PC) or a mobile phone capable of communication over the Internet. In this example, the second device 204 can be a server (e.g., used or accessed by an online store accessible over the Internet) capable of verifying redemption codes.

In the exemplary configuration depicted in FIG. 3, the first device 202 is configured with an image-based redemption code extraction component 202a which can be similar to the image-based redemption code extraction component 102 of the image-based value redemption system 100 depicted in FIG. 1. As such, the image-based redemption code extraction component 202A can be operable to determine (or effectively extract) a redemption code from the image 208 of a redeemable instrument 210. It should be noted that the first device 202 may optionally include an image capture component (e.g., a camera) 202B operable to capture the image 208 of the redeemable instrument 210. In any case, the first device 202 can be operable to determine a redemption code from the image 208 and transmit the redemption code via the network 206 to the second device 204 for verification.

A redemption code verification component 204A of the second device 204 can verify the redemption code transmitted by the first device 202. The redemption code verification component 204A can operate similar to the redemption code verification component 110 of the image-based redemption code extraction component 102 depicted in FIG. 1. As such, the redemption code verification component 204A can, for example, use a verification technique in order to verify the redemption code transmitted by the first device 202. The redemption code is for redeeming a value associated with the redeemable instrument 210. Successful verification of the redemption code by the verification component 204A can result in transmission of an acknowledgment of the verification to the first device 202. In addition, successful verification of the redemption code can ultimately result in redemption of a redemption value associated with the redeemable instrument 210 (e.g., a $50 value may be credited to an account and/or an individual). It should be noted that the second device 204 may optionally include a value redemption component 204B operable to allow or facilitate redemption, or complete the redemption process. This may include, for example, crediting the user with the appropriate amount associated with the verified redemption code. For example, a user typically has an account with an online store, and such account can be credited with the appropriate amount of the redeemable instrument 210.

On the other hand, the second device 204 may send a notice of failure to verify the redemption code to the first device 202. As a result, the first device 202 may attempt to determine the correct redemption code again, for example, by processing the same image 208 again (e.g., with different or more complex image processing/recognition techniques), processing another image of the redeemable instrument 210, or perform error recovery to yield the correct redemption code. It should be noted that the first device 202 may also be configured to transmit the image 208 to the second device 204 for processing.

Referring to FIG. 3, the second device 204 may optionally be configured with an image-based redemption code extraction component 204C. In comparison to image-based redemption code extraction component 202A of the first device 202, the image-based redemption code extraction component 204C of the first device 204C may have more computing resources and capable of performing a more thorough image processing or a more complex analysis of the image 208. As such, the second device 204 may also provide more complex error handling. However, it may be preferred to perform error handling at the first device 202 for security reasons. As a last resort, a human operator may be able to interact with the second device 204 to determine the redemption code from the image 208, for example, by visually inspecting the image 208. Accordingly, with the communication environment 200, the redemption code need not be entered manually via the first device 202 but it should be noted that first device 202 may also be configured to allow a user to enter a redemption code manually.

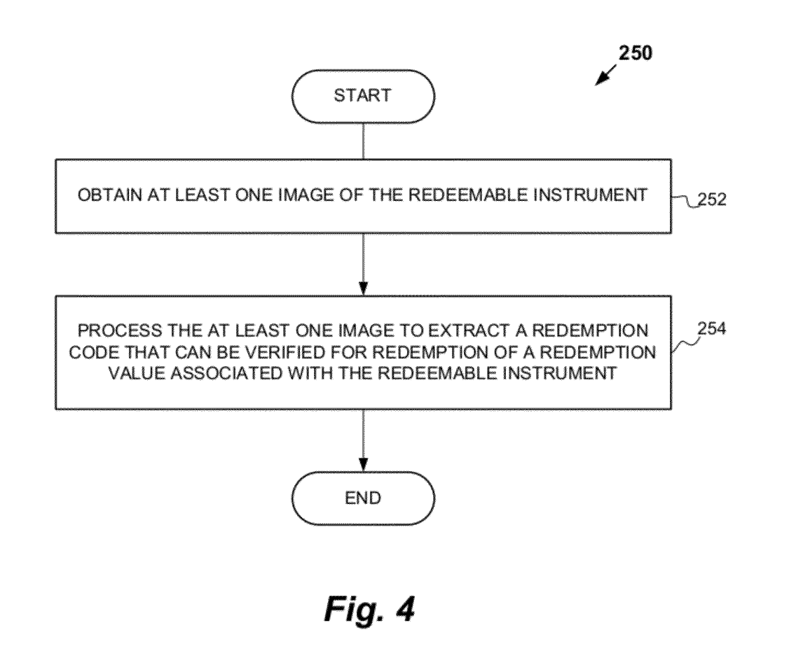

FIG. 4 depicts a method 250 for processing a redeemable (or redemption) instrument in accordance with one exemplary embodiment. Typically, the redeemable instrument is indicative of a redemption value. Method 250 can, for example, be used by the first device 202 or the second device 204 depicted in FIG. 3. Referring to FIG. 4, initially, at least one image of the redeemable instrument is obtained (252). Next, one or more images of the redeemable instrument are processed (254) to extract a redemption code. It should be noted that typically the redemption code can be verified for redemption of a redemption value associated with the redeemable instrument.

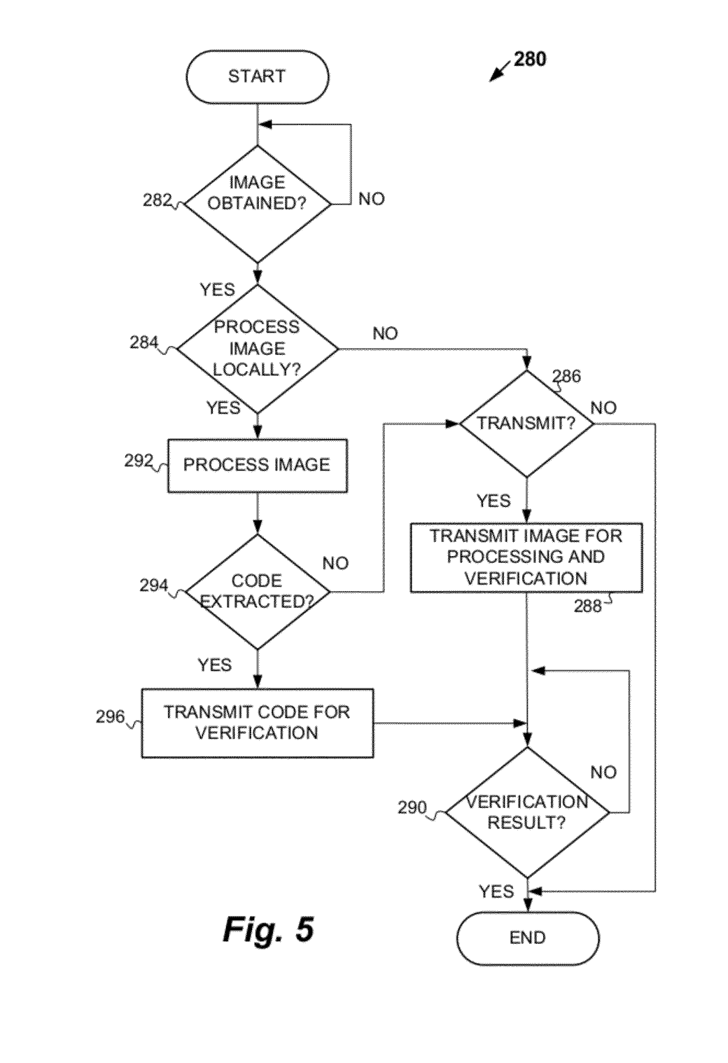

To further elaborate, FIG. 5 depicts a method 280 for processing a redeemable (or redemption) instrument in accordance with another exemplary embodiment. Typically, the redeemable instrument is indicative of a redemption value. The method 280 can, for example, be used by the first device 202 depicted in FIG. 3. Referring to FIG. 5, initially, it is determined (282) whether at least one image of the redeemable instrument has been obtained. In effect, method 250 can wait until it is determined (282) that an image of the redeemable instrument has been obtained. If it is determined (282) that an image has been obtained, it can be determined (284) whether to process the image locally (e.g., whether image it to be processed on first device 202 depicted in FIG. 3). Those skilled in the art will readily appreciate that the determination (284) of whether to process the image can, for example, vary with implementation. For example, the determination (284) can be made based on one or more criteria (e.g., image brightness, amount of motion or movement during image capture, quality of the image, degree of confidence that a redemption code can be extracted from the image, user preference or input, etc.). Generally, a degree of confidence can be determined based on one or more criteria in order to determine (284) whether to proceed with processing the image locally. For example, if the image is rather dark, the degree of confidence for the image is low, and thus another image might instead be used. As another example, if the amount of movement during capture of the image is rather high, the degree of confidence for the image is low, and thus another image might instead be used.

If it is determined (284) not to process the image locally, it can be determined (286) whether to transmit at least one image of the redeemable instrument for processing and extraction of a redemption code associated with the redeemable instrument. If it is determined (286) not to transmit an image of the redeemable instrument, the method 280 can end. However, if it is determined (286) to transmit at least one image of the redeemable instrument, one or more images of the redeemable instrument can be transmitted (288) for processing. Typically, an image can be transmitted to another device (e.g., second device 204) for processing. The processing can include extraction of a redemption code and verification of the redemption code. After transmission (288) of one or more images, the method 280 can effectively wait (290) for a verification result. Typically, the verification result is indicative of a successful or unsuccessful verification of the redemption code extracted from the image of the redeemable instrument. Unsuccessful verification may include failure to extract a redemption code from the image and possibly other situations where the redemption code cannot be ultimately verified. For example, even if a redemption (or verification) code is extracted successfully, the verification may still be unsuccessful if the redemption code has already been used, or a redeemable coupon has expired. In effect, method 280 can wait (290) to receive a verification result. Method 280 can end after a verification result has been received.

On the other hand, if it is determined (284) to process one or more images of the redeemable instrument, the image(s) can be processed (292). Thereafter, it can be determined (294) whether a redemption code has been extracted (294) from at least one image of the redeemable instrument. In other words, it can be determined (294) whether processing of the image has extracted a redemption code. If it is determined (294) that a redemption code has not been extracted, it can be determined (286) whether to transmit at least one image of the redeemable instrument to another device for more sophisticated processing. Here, the method 280 can proceed in a similar manner as discussed above to transmit (288) one or more images to another device (e.g., second device 204) and await (290) a verification result. However, if it is determined (294) that a redemption code has been extracted from at least one image of the redeemable instrument as a result of the image processing (292), the redemption code can be transmitted (296) to another device for verification. After transmission of the redemption code, the method 280 can effectively wait (290) for a verification result. Method 280 can end after the verification result has been received from the another device.

As noted above, mobile devices are extremely popular today. In fact, mobile devices are likely to eventually become the device of choice worldwide. Similarly, transaction cards (e.g., gift cards) are being widely used today. As such, a mobile device using a transaction card will be discussed in greater detail below.

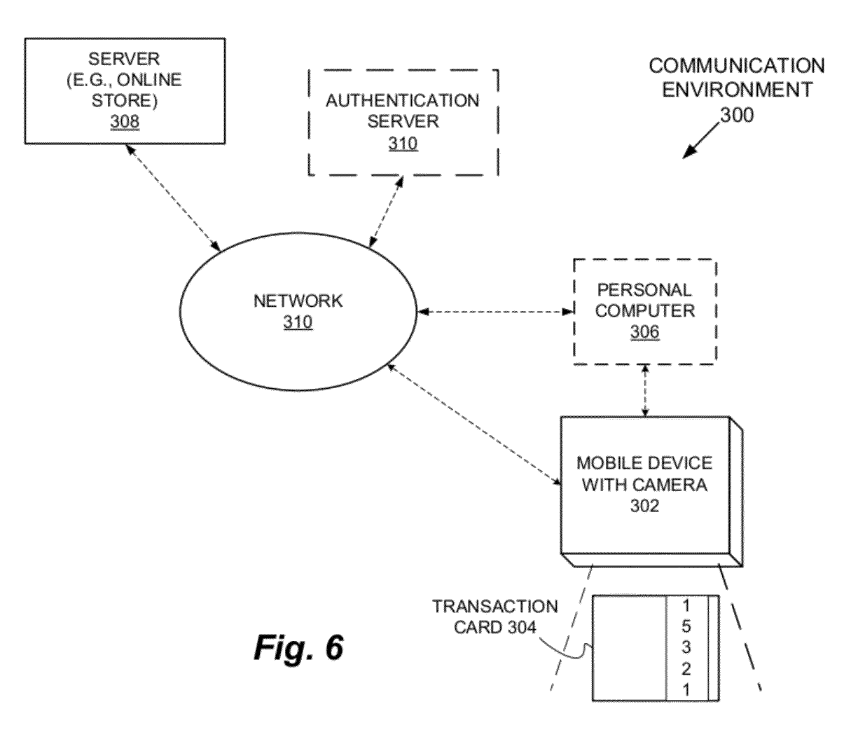

To further elaborate, FIG. 6 depicts a mobile device 302 in communication environment 300 in accordance with one exemplary environment. Referring to FIG. 6, the mobile device 302 may be equipped with a camera operable to capture (or take) pictures and/or video of a transaction card 304 with a redemption code represented as “15321”, as a simplified example. It should be noted that the camera need not necessarily be integrated with the mobile device 302. As such, the camera can, for example, be “tethered” to 302 via a cable, or the camera can be a consumer camera using Wi-Fi to transmit images wirelessly to device 302. The mobile device 302 can, for example, be a mobile phone (including smartphone), or a media player equipped with at least a camera. In any case, the mobile device 302 can communicate directly or indirectly by a connection (wired or wireless) via a personal computer 306 to a server (e.g., online store) 308. Communication may be over a network 310 facilitated by various other devices (not shown) as is generally known in the art.

A redemption process may be initiated by establishing a communication with the server 308 and effectively requesting redemption of a value of the transaction card 304. As a result, the mobile device 302 and/or server 308 can effectively provide the user of the mobile device 302 with the option of taking an image of the transaction card 304 instead of entering the redemption code (“15321”) manually. If this option is selected by the user, the mobile device 302 can be configured to set (or preset) one or more parameters associated with the camera in order to provide a better image of the transaction card for analysis. These parameters may be provided by the server 308 but it may be more feasible that the mobile device 302 be configured to at least initially preset or set camera parameters locally as it may be easier to discern the appropriate parameters for capturing an image locally. By way of example, camera shutter speed may be set to a determined minimum value before an image of the transaction card 304 is captured by the camera. As another example, flash light control and/or focus control can be configured to be more optimal for use in capturing an image of a transaction card. It should also be noted that these one or more parameters will vary with different mobile devices.

Generally, one or more images of the transaction card 304 can be captured by the camera of the mobile device 302 for processing and extraction of the redemption code (“15321”). There are numerous ways to capture one or more images of the transaction card 304 for processing. For example, a person may manually operate the camera to take one or more pictures of the transaction card. As another example, a person may be prompted to place the camera in front of the transaction card 304 so that the mobile device 302 can capture a video or as many pictures that are likely to be required for processing. As such, a video may be taken for a determined amount of time or until at least one image meeting a determined threshold of quality is obtained and so on. In other words, the mobile device 302 can be configured to pre-process images and select one or more images that are likely more useful among several images that may have been obtained for extraction of the redemption code (“15321”). Generally, an image of the transaction card 304 may be screened or checked for usability before it is used for the extraction process (i.e., extraction of the redemption code). As such, an image can be rejected prior to performing the extraction process on that image, and the mobile device 302 can, for example, be configured to prompt the user to take another image.

It will be appreciated that the mobile device 302 can also be configured to effectively provide feedback to assist the user in taking an image more suitable for the extraction process. Generally, feedback can be provided before or after an image is taken based on pre-screening or analyzing the image, for example by sampling a number of pixels. Feedback can be provided from a variety of sources that may be included in or available to or the mobile device 302. By way of example, if a low camera shutter speed is detected in conjunction with motion sensed by an accelerometer of the mobile device 302, it can be determined that the camera is not being held steady enough. Accordingly, the mobile device 302 can prompt the user to hold the camera more steadily and/or provide more light to compensate for the motion and lower shutter speed. As another example, if a Global Positioning System (GPS) of the mobile device 302 detects movement and the shutter speed is determined to be low, the mobile device 302 can prompt the user to stop moving and/or provide more light. A lower shutter speed for the camera in itself may result in feedback to the effect that more light is needed. Similarly, if an ambient light sensor of the mobile device 302 detects an amount of light determined to be low, the mobile device 302 can be configured to prompt the user for more light. As yet another example, feedback can be provided based on the focus distance of the camera which may be reported by the camera itself. The focus distance can be used to determine how far the transaction card 304 is from the camera. Accordingly, the mobile device 302 can use the focus distance to prompt the user when the transaction card 304 is too close or too far from the camera.

Feedback can also be provided based on an image of the transaction card 304. By way of example, image analysis or screening of an image can determine that the image is too dark or lacks sufficient contrast. As a result, the mobile device 302 can prompt the user to add more light. In the unlikely situation when an image is determined to be too bright or bright enough but determined to lack sufficient contrast, the mobile device 302 can prompt the user that less light is needed.

It will also be appreciated that additional features provided for the transaction card 302 can be used to provide feedback. One such feature is “landmarks” provided on the transaction card 304. The landmarks are visual references that can be provided (e.g., printed) on the transaction card 302. As an example, the landmarks can be characters, shapes, and the like that are placed on the transaction card 302. The landmarks can be placed at one or more positions on the transaction card 302 at know placement relative to placement of the redemption code provided on the transaction card 302. Extraction of the redemption code (“15321”) from the transaction card 304 can be accomplished by first locating the redemption code in the image. Various landmarks can be used to effectively locate the redemption code (“15321”) on the transaction card 304. As such, the landmarks can be useful in image processing to recognize the redemption code in the image. For example, the landmarks can help reference the orientation and position of the redemption code within the image. These landmarks can also be used to provide feedback to a user of the mobile device 302. For example, if landmarks cannot be detected in the image, the mobile device 302 can prompt the user that a valid transaction card could not be detected. As another example, if landmarks are detected to be too close to each other, it can be determined that the transaction card 304 is being held too far away from the camera.

Processing an image of the transaction card 304 may entail several phases and/or operations. As noted above, landmarks can be used to locate a redemption code. In addition, perspective transformation can be performed to, compensate for skewing in an image. Here, a predetermined shape can be provided on the transaction card 304. For example, the predetermined shape can correspond to a boundary box provided around a redemption code. The predetermined shape can be use for evaluating whether the image is skewed (though the predetermined shape can also act as a landmark). For example, if the predetermined shape is a rectangular box (with or without rounded corners), the processing of the image can initially evaluate whether the predetermined shape is recognized in the image as a rectangular box. If the predetermined shape is recognized in the image as a substantially rectangular box, then the image is deem not skewed and can be further processed to extract the redemption code. On the other hand, if the predetermined shape is not recognized in the image as a substantially rectangular box, then the image is deem skewed and further processing can be performed to transform the skewed image to an unskewed version where the predetermined shape in the image has its expected shape (e.g., rectangular box). The redemption code may also be isolated and/or enhanced to further facilitate extraction of the redemption code.

It should be noted that multiple images can be processed to improve accuracy, and statistical analysis can be used to determine the redemption code. As such, when four (4) images indicate the presence of a particular character (e.g., “B”) in a particular position and only one image indicates the presence of a different character (e.g., “D”) in the same position, the character indicated by the four (4) images (“B”) can be identified as a more likely possibility than the character (“D”) indicated by only one of the images.

Generally, the redemption code can be extracted using a code recognition or code analysis algorithm. The specific code analysis algorithm used typically depends on the type of the coding mechanism used to generate the redemption code, as will be readily appreciated by those skilled in the art. For example, a QR code analysis algorithm can be used for 2D bar code provided as a redemption code. For alphanumeric redemption codes, a general or customized OCR algorithm can be used to recognize (or effectively read) each one of the alphanumeric characters that collectively represent a redemption code that can be provided (e.g., printed) on the transaction card 304. Today, alphanumeric redemption codes are more often used especially on gift cards, and it may be more feasible to continue to use alphanumeric values in order to continue to provide users with the ability to read and enter redemption codes in case some individuals prefer to do so or as a last resort after attempts to automatically detect the redemption codes have failed. However, more often than not, image analysis can result in determination or extraction of a redemption code from one or more images. In addition, customized algorithms, machine learning, and other techniques can improve the efficiency of code extraction process. Error handling may also be used to further increase the likelihood of successfully extracting redemption values. An extracted redemption code can be provided to the server 308 for verification. It should also be noted that additional information, including one or more code values (or coded values,) can also be extracted from the image of the transaction card 304. By way of example, a bar code or serial number can be extracted from the image of the transaction card 304.

Referring back to FIG. 6, the mobile device 302 can transmit the extracted redemption code for verification to the server 308. Successful verification of the extracted redemption code by the server 308 can result in redemption of a value (or credit) associated with the transaction card 304. It should be noted that an authentication server 310 may perform the validation and/or authentication of the redemption value or at least take part in the validation and/or authentication processes.

On the other hand, unsuccessful verification of the extracted redemption code by the server 308 can result in allowing the mobile device 302 to transmit another redemption code. The mobile device 302 can be configured to capture another image of the transaction card 304 and/or perform error recovery. As an example, for alphanumeric redemption codes, common image-reading errors can be considered. For example, an “I” character may be replaced by “L,” or an “8” may be replaced by “B,” and so on. In one embodiment, a database of common image-reading error is provided to allow regeneration of a redemption code by substituting one or more characters in an attempt to correct common image-reading errors that may have occurred. It should also be noted that a detection algorithm can be used to provide statistical confidence of each letter/code “chunk”. This statistical confidence can then be used to determine which letters to try replacing first.

If error recovery is unsuccessful, the same image must be reprocessed or a new image can be processed. As such, the mobile device 302 can extract another redemption code and transmit it for verification to the server 308 or authentication server 310. The number of attempts that can be made may, for example, be determined by the server 308. After several unsuccessful verifications, or simply based on user request, the server 308 may be configured to allow the mobile device 302 to transmit one or more images of the transaction card to the server 308 for processing. The processing may be performed by the server 308 or other devices, which may have far greater computational resources and capabilities for extracting the redemption code. The server 308 or another designated device may also have better error resolution capabilities with which to evaluate images for alternative redemption codes. Though, error resolution can be used, it should be restricted so that reliability and security are not significantly compromised. A human operator may even be employed to visually inspect an image received by the server 308 in the event the verification fails. In addition, the mobile device 302 may allow the user to manually enter a readable redemption code (e.g., an alphanumeric value) and submit it for verification to the server 308, or the authentication server 310 if automated verification fails.

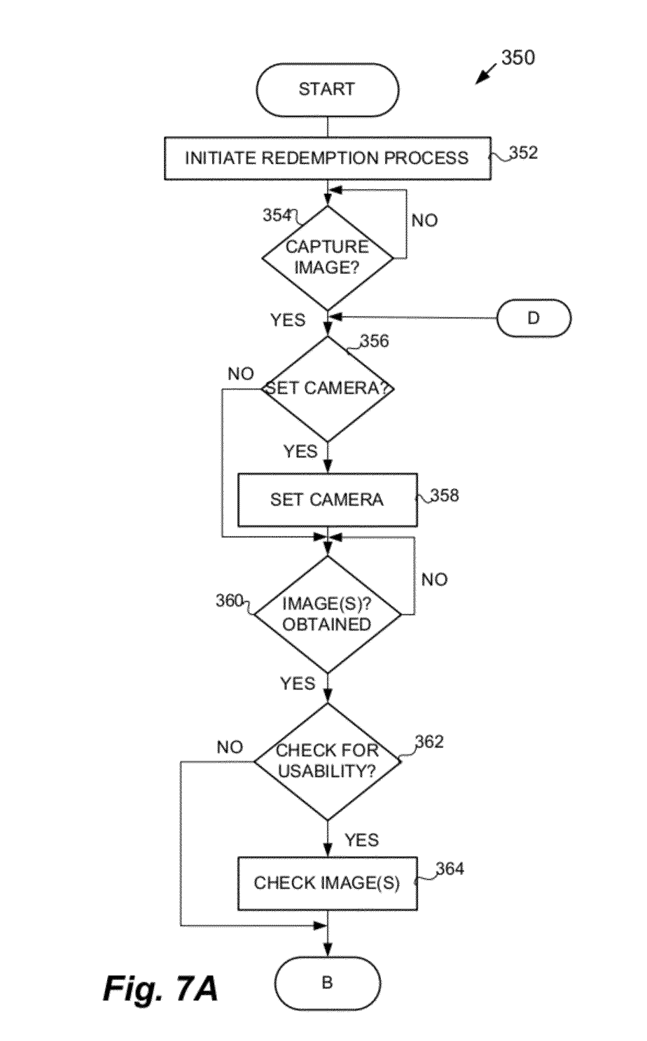

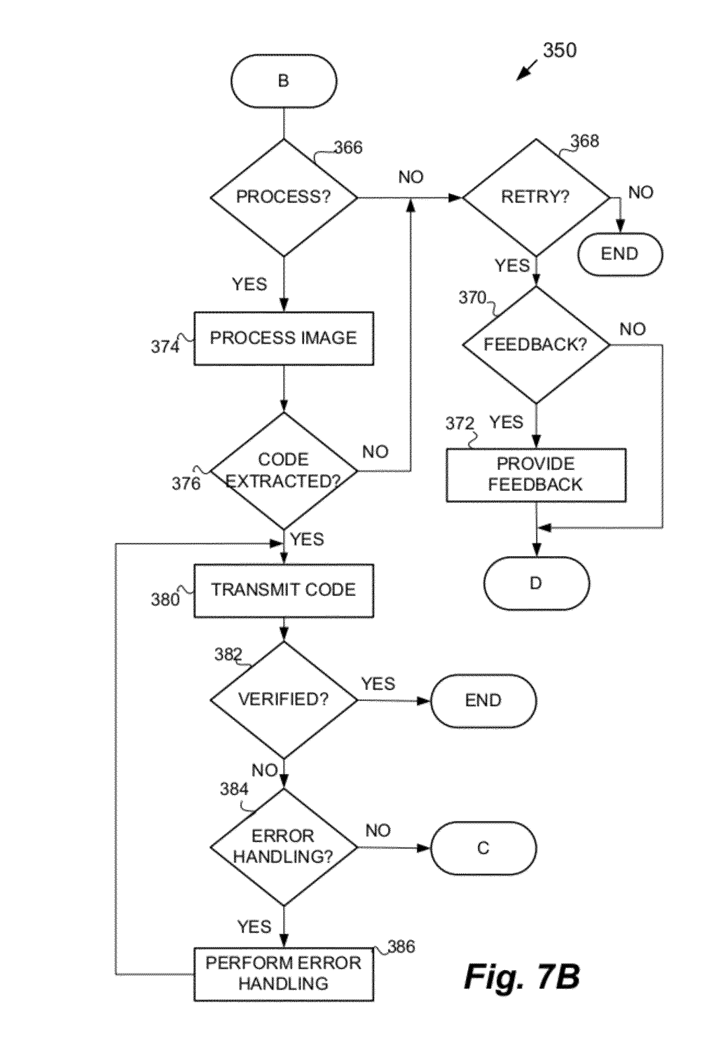

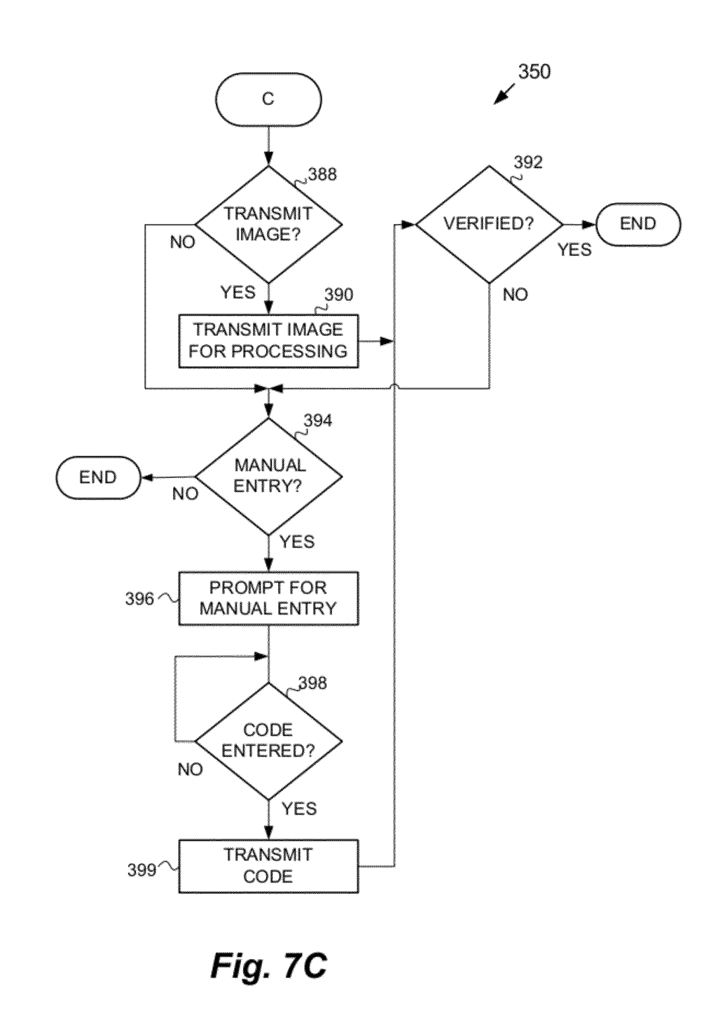

FIGS. 7A, 7B and 7C depict a method 350 for processing a redeemable (or redemption) instrument in accordance with yet another exemplary embodiment. Typically, the redeemable instrument is indicative of a redemption value. The method 350 can, for example, be used by the mobile device 302 depicted in FIG. 6.

Referring to FIG. 7A, initially, a redemption process is initiated (352). By way of example, a redemption process can be initiated by initiating a process (e.g., application or utility program) that might communicate with a server (e.g., server 308 and/or authentication server 310 shown in FIG. 6) and effectively requesting redemption of a redemption value associated with the redeemable instrument. After initiation (352) of the redemption process, it is determined (354) whether to capture an image of the redeemable instrument. In other words, it can be determined (354) whether to use an image of the redeemable instrument to redeem its redeemable value. By way of example, a user can be provided with an option to capture an image of the redeemable instrument.

If it is determined (354) to capture an image, it can be determined (356) whether to set or preset the camera. As a result, one or more camera parameters can be set or preset (358) before an image of the redeemable instrument is captured. By way of example, shutter speed of the camera can be set to a minimum or a determined value. Next, it can be determined (360) whether an appropriate number of images of the redeemable instrument have been captured. For example, it can be determined (360) whether at least one image has been captured or a predetermined number of images have been captured. Images can, for example, be captured as a single or still images, or as video captured in real time.

In any case, after it is determined (360) that an appropriate number of images have been captured, the image(s) can be checked (362) for usability. In other words, one or more captured images can be screened to determine if they are suitable for processing to extract a redemption code. Accordingly, one or more images of the redeemable instrument can be checked (364) for usability before processing them for code extraction. After the usability of the image(s) has been checked (364), it can be determined (366) whether to process at least one of the images (shown in FIG. 7B). If it is determined (362) not to check at least one image of the redeemable instrument for usability, method 350 can proceed directly to determine (366) whether to process at least one of the images (shown in FIG. 7B) without checking images for usability. Those skilled in the art will readily appreciate that the determination (362) of whether to check images for usability can, for example, represent a design choice, or can be made based on the capabilities or preferences of a device.

Referring now to FIG. 7B, it is determined (366) whether to process one or more images. If it determined (366) not to process at least one image, it can be determined (368) whether to retry the image capture process. The determination (368) of whether to retry the image capture process can, for example, represent a design choice or be made based on user input. If it is determined (368) not to retry the image capture process, the method 350 can end. On the other hand, if is determined (368) to retry the image capture process, it can be determined (370) whether to provide feedback. Accordingly, feedback can be provided (372) before the image capture process is retried by again determining (356) whether to set the camera (shown in FIG. 7A) and thereafter proceeding in a similar manner as discussed above. Feedback can, for example, be provided based on preprocessing of an image and/or one or more parameters such as the exemplary parameters noted above. If it is determined (370) not to provide feedback, the method 350 can proceed directly to determine (356) whether to set the camera.

Referring to FIG. 7B, if it is determined (366) to process at least one captured image of the redeemable instrument, one or more images can be processed (374) to extract a redemption code therefrom. Thereafter, it can be determined (376) whether a redemption code has been extracted. If it is determined (376) that no redemption code has been extracted, it can be determined (368) whether to try the image capture process again and the method 350 can proceed in a similar manner as discussed above to possibly provide feedback (372) and/or set (358) the camera before one or more new images are captured. On the other hand, if it is determined (376) that a redemption code has been extracted, the redemption code can be transmitted (380) for verification. Thereafter, it can be determined (382) whether the redemption code has been verified. In effect, method 350 can wait to receive a verification notice indicative of successful or unsuccessful verification of the transmitted redemption code. If the redemption code has been verified successfully, the method 350 can end. However, if the redemption code cannot be successfully verified (382), it can be determined (384) whether to perform error handling. If desired, error handling can be performed (386). Error handling can, for example, be performed by substituting one or more characters associated with commonly misread characters as noted above. In addition, error handling (386) can result in a redemption code that can be transmitted (380) for verification as discussed above.

If it is determined (384) not perform error handling, perhaps after a number of attempts, it can be determined (388) whether to transmit one or more images for processing (shown in FIG. 7C). Accordingly, one or more images can be transmitted (390) for processing, and method 350 can wait (392) for verification of the transmitted redemption code to receive a successful or unsuccessful verification result. If the redemption code is successfully verified, method 350 can end. However, if the redemption code is not successfully verified or if it is determined (388) not to transmit an image for processing, perhaps after a number of previous attempts, it can be determined (394) whether to allow manual entry of the redemption code, and a user can be prompted (396) for manual entry of the redemption code accordingly. Thereafter, method 350 can effectively wait (398) for a redemption code to be manually entered. After the redemption code has been manually entered, the redemption code can be transmitted (399) for verification. Method 350 can effectively wait (392) for a verification response indicative of successful or unsuccessful verification of the redemption code that has been manually entered. If the manually entered redemption code is not able to be successfully verified, method 350 can provide another opportunity for a redemption code to be manually entered and verified. If it is determined (394) not to allow manual entry, for example, after a maximum number of allowed attempts has been reached (e.g., five (5) attempts), method 350 can end. Method 350 can also end as a result of successful verification (392) of the redemption code.

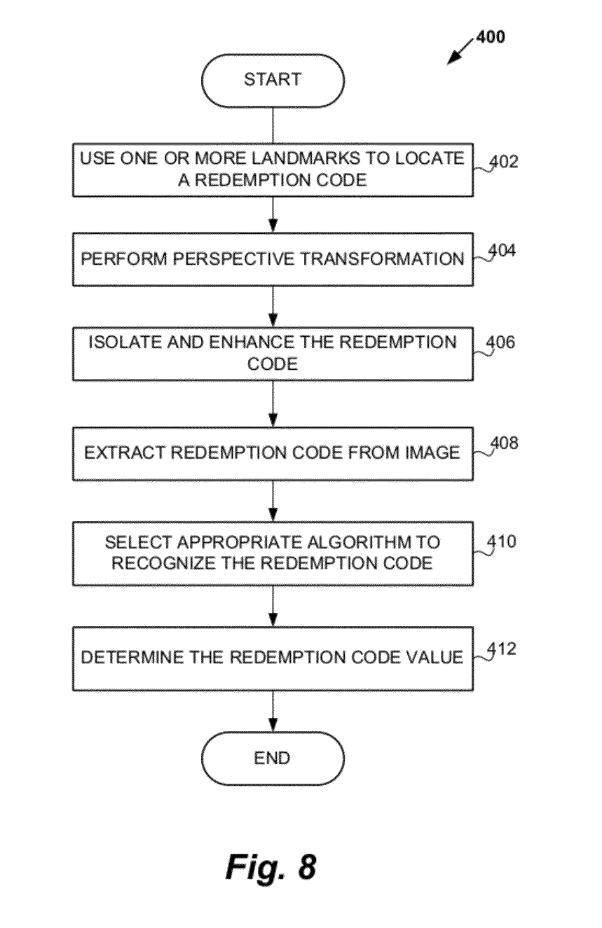

FIG. 8 depicts a method 400 for extracting a redemption code from an image of a redeemable instrument in accordance with an exemplary embodiment. Typically, the redeemable instrument is indicative of a redemption value. The method 400 can, for example, can be used by the mobile device 302 depicted in FIG. 6.

Referring to FIG. 8, initially, one or more landmarks are used (402) to locate an image of a redemption code in an image captured from a redeemable instrument. Next, perspective transformation can be preformed (404). As noted above, the perspective transformation can, for example, be made based on landmarks or known shapes (e.g., square shape of the area where the redemption code is encoded). In addition, the image of the redemption code can be isolated and enhanced (406) and the image of the redemption code extracted (408). Thereafter, an appropriate code recognition algorithm is selected (410) to recognize (or effectively read) a redemption code depicted in the extracted image of the extracted redemption code. By way of example, for an alphanumeric code, a general or customized OCR algorithm can be selected. As another example, for a QR code, a QR algorithm can be selected. Finally, a redemption code value is determined (412) using the selected code recognition algorithm. Method 400 can end after the redemption code value is determined (412).

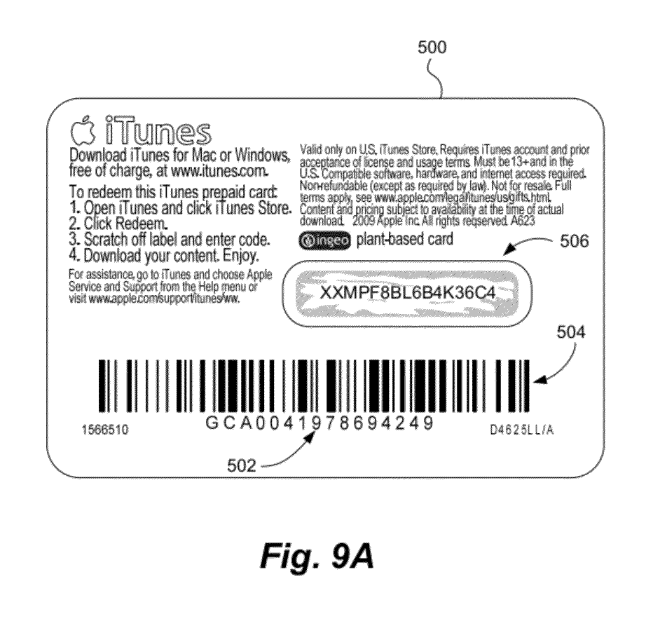

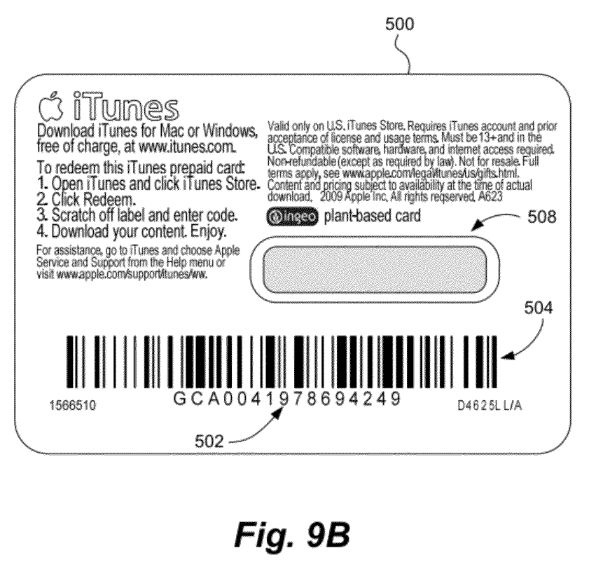

FIGS. 9A and 9B depict an exemplary prepaid or gift card 500 suitable for verification and redemption by image-based verification and redemption techniques described above. Referring to FIG. 9A, a public number 502 is visible on the prepaid or gift card 500. In addition, a bar code 504 is provided for the prepaid or gift card 500. An alphanumeric code 506 represents the redemption code as a private or secret code. The alphanumeric code 506 can be initially sealed or made invisible by a layer of material 508 (e.g., security layer) that can be scratched off to reveal the private or secret redemption code 506. FIG. 9A illustrates the alphanumeric code 506 being visible after removal of the layer of material 508. It should be noted that residue of material 508 may be present on or in the proximity of the alphanumeric code 506 after removal of the layer material 508. Presence of the residue can make the determination of the alphanumeric code 506 more challenging. FIG. 9B illustrates the alphanumeric code 506 being covered and thus not visible due to the presence of the layer of material 508.

It should be noted that the steps associated with the described methods may vary widely. Steps may be added, removed, altered, combined, and reordered without departing from the spirit of the scope of the present invention. By way of example, referring to FIG. 7C, after transmission (388) of an image for processing, it is possible to capture (354) an image of a transaction card (shown in FIG. 7A). As another example, after manually entering (396) the redemption code and unsuccessful verification of the transmission code, it is possible to allow transmission (390) of one or more images of the transaction card (shown in FIG. 7C), or allow capturing (354) an image of the transaction card (shown in FIG. 7A). Numerous other additions, deletions, alterations, combinations, and reordering of operations will be readily apparent.

The various aspects, features, embodiments or implementations of the invention described above can be used alone or in various combinations.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method of processing a redeemable instrument having a redemption value, the computer-implemented method comprising:
obtaining at least one image of at least a portion of the redeemable instrument; and
processing the at least one image in order to extract a redemption code that can be verified for redemption of the redemption value associated with the redeemable instrument.

2. The computer-implemented method of claim 1, wherein the computer-implemented method further comprises:
transmitting the extracted redemption code for verification of the redemption code.

3. The computer-implemented method of claim 2, wherein the computer-implemented method further comprises:
verifying the redemption code.

4. The computer-implemented method of claim 3, wherein the computer-implemented method further comprises:
determining whether the redemption code has been successfully verified; and
allowing redemption or facilitating redemption of the redeemable value after successful verification of the redemption code.

5. The computer-implemented method of claim 1, wherein the computer-implemented method further comprises one or more of the following:
determining, based on one or more properties of the at least one image, whether to process the at least one image;
processing the at least one image based on one or more properties of the at least one image;
providing feedback regarding the at least one image; and
performing error handling to determine a redemption code.

6. A computer-implemented method of processing a transaction card that includes a redemption code associated with a redeemable value, the computer-implemented method comprising:
locating an image of a redemption code in an image of the transaction card;
processing the image of the redemption code to extract one or more characters representative of the redemption code; and
transmitting the one or more extracted characters as the redemption code for verification of the redemption code.

7. The computer-implemented method of claim 6, wherein the locating of the image of the redemption code uses at least one reference mark to assist in locating the image of the redemption code on the transaction card.

8. The computer-implemented method of claim 6, wherein the computer-implemented method comprises:
capturing a plurality of images of the transaction card;
determining whether each of the images of the transaction card or redemption code is suitable for the processing; and
selecting at least one image from the plurality of images of the transaction card for the processing in order to determine the one or more characters representative of the redemption code.

9. The computer-implemented method of claim 6, wherein the computer-implemented method further comprises one or more of the following:
providing feedback regarding the image of the transaction card;
providing feedback regarding how an image of the transaction card is to be captured;
performing error handling to substitute at least one of the one or more characters with another character;
performing error handling based on common image-reading errors; and
prompting for manual entering of the redemption code after a failure to determine the one or more characters or after a failure to verify the redemption code.

10. The computer-implemented method of claim 6, wherein the processing of the image of the redemption code to determine one or more characters comprises one or more of the following:
performing perspective transformation; and
isolating the redemption code.

11. The computer-implemented method of claim 6, wherein the processing of the image of the redemption code to determine one or more characters comprises:
performing image processing to enhance the image of the redemption code; and
extracting one or more characters representative of the redemption code from the enhanced image.

12. The computer-implemented method of claim 6, wherein the processing of the image of the redemption code to determine one or more characters comprises:
selecting and performing an image analysis algorithm based on the type of the redemption code.

13. The computer-implemented method of claim 12, wherein the image analysis algorithm is one of the following: a QR code analysis algorithm for 2D Barcodes, a general OCR algorithm for alphanumeric values, or a customized pattern-recognition algorithm for alphanumeric values.

14. The computer-implemented method of claim 6, wherein the transaction card is a prepaid card or a gift card with the redemption code depicted thereon.

15. The computer-implemented method of claim 6, wherein the computer-implemented comprises:
processing a plurality of images to determine the redemption code.

16. The computer-implemented method of claim 6, wherein the computer-implemented comprises:
determining based on the image of the transaction card at least another code value for the transaction card.

17. A computer-implemented method of allowing redemption of a redeemable value associated with a redeemable instrument, the computer-implemented method comprising:
obtaining at least one image of the redeemable instrument;
determining a redemption code at least partly based on the at least one image of the redeemable instrument;
determining whether the redemption code is valid; and
allowing the redeemable value to be redeemed if the determining determines that the redemption code is valid.

18. The computer-implemented method of claim 17, wherein the redeemable instrument is a transaction card and the redeemable value is representative of a monetary value.

19. The computer-implemented method of claim 17, wherein the determining of the redemption code comprises:
analyzing the at least one image of the redeemable instrument to determine the redemption code.

20. The computer-implemented method of claim 17, wherein the redemption code is provided as a human readable value covered by a cover layer that can be peeled or scratched off to expose the redemption code.

21. The computer-implemented method of claim 17, wherein the computer-implemented method further comprises:
allowing the redemption code to be entered manually when the redemption code cannot be determined or validated based on the at least one image of the redeemable instrument.

22. A computer readable storage medium including at least computer program code stored therein for redeeming a value associated with a redeemable instrument, the computer readable storage medium comprising:
computer program code for obtaining at least one image of the redeemable instrument;
computer program code for determining a redemption code at least partly based on the at least one image of the redeemable instrument;
computer program code for determining whether the redemption code is valid; and
computer program code for allowing the redeemable value to be redeemed if the determining determines that the redemption code is valid.
